(19) United States
(12) Patent Application Publication
(10) Pub. No.: US 2017/0044795 A1
(43) Pub. Date: Feb. 16, 2017

(54) Shipping Container Tool

(71) Applicant: Arthur Allen Nelson, North Charelston, SC (US)

(72) Inventor: Arthur Allen Nelson, North Charelston, SC (US)

(21) Appl. No.: 15/307,033

(22) PCT Filed: Apr. 29, 2015
(86) PCT No.: PCT/US15/28109

§ 371 Date: Oct. 27, 2016

Related U.S. Application Data
(60) Provisional application No. 61/985,541, filed on Apr. 29, 2014.

(51) Int. Cl. E05B 1/00

(52) U.S. Cl. CPC E05B 1/0053

(57) ABSTRACT

A tool for closing a shipping container door comprises a head with two extensions curving away from the head and having a space between them sufficient to accommodate a bar bracket of a locking bar on a shipping container door. The head also has a handle that can function as a lever, so that when the tool engages the locking bar about the bar bracket, an operator can close and secure the shipping container door. Optionally, the tool also includes other components, such as features to engage other mechanisms useful in shipping, such as locking bars for opening shipping container doors, and twist locks for coupling and uncoupling shipping containers.

### RELATED APPLICATIONS

This application claims benefit of priority under PCT Chapter I, Article 8, and 35 U.S.C. §119(e) of U.S. Provisional Patent Application No. 61/985,541 entitled, “SHIPPING CONTAINER TOOL” filed Apr. 29, 2014, which is incorporated herein by reference in its entirety.

### TECHNICAL FIELD

This invention relates to tools useful for closing and securing shipping container doors. Further embodiments provide tools for opening, coupling and uncoupling, and otherwise handling shipping container doors, among other useful purposes.

### BACKGROUND ART

Intermodal shipping containers find ubiquitous use throughout the world. Transporting everything from bulk raw materials to refined goods, millions of shipping containers move each day. Their strength and standardized dimensions allow their transport by cargo ship, train, truck, and occasionally by airplane. Those shipping containers have simplified and dramatically expanded global trade, and significantly reduced the danger to longshoremen and warehousemen who handle cargo. Nonetheless, shipping containers present a significant risk to longshoremen, truckers, warehousemen, and anyone else tasked with closing and securing the shipping container doors.

The risk posed by the shipping container doors stems from the weakest aspect of the shipping container design: the doors and their locking bars represent relatively delicate features of the otherwise sturdy containers. The doors, locking bars, latches, and hinges frequently receive damage during handling, making it difficult to close and secure the doors. Also, corrosion limits the facile working of the locking bar mechanism and hinges. In addition, unsecured cargo shifting around inside the container can press against the door, damaging the locking bars and latches, or simply making it difficult to close the door.

Currently, longshoremen and warehousemen employ a very dangerous procedure to close a faulty door on a shipping container: a forklift presses against the door, the locking bar bracket, or the locking handle, and a person manually secures the locking handle with the latch. If the forklift prong slips off the locking bar bracket or locking handle, the locking handle can spring open at great speed. If the person manually operating the locking handle and latch is too close, the person can be severely injured or killed.

Sometimes, it is discovered that a door is not securely closed, yet no forklift or other machinery is available to close the shipping container door. For example, the shipping containers can be stacked on a cargo ship with limited space or at a great height, preventing a forklift from reaching the container door. Or a trucker transporting a shipping container on a truck chassis may need to open the shipping container for inspection at a border crossing or hazardous material checkpoint, and then re-secure the shipping container door. If the door, locking bar mechanism, or latches are difficult to operate, the trucker may be unable to close and secure the shipping container door and resume his journey. Similarly, the doors, locking bars, hinges, and latches on a standard tractor-trailer or box truck or railway boxcar may also suffer from damage due to collision or corrosion, and it may be difficult to close and secure those doors. Currently, there is no safe and effective way to close and secure those doors.

Unexpectedly, Applicant has discovered a new and useful means for closing and securing the doors of intermodal shipping containers, the doors of tractor-trailers and box trucks, railway boxcars, and similar vessels for transporting cargo.

### SUMMARY OF INVENTION

Some embodiments of the present invention provide tools for closing a shipping container door, comprising:

a head that comprises
a front face and a rear face that together define a top edge;
two extensions proximal to the top edge extending from the front face, and
spaced apart along the top edge a distance sufficient to accommodate a bar bracket of a locking bar on the shipping container door;
   a handle extending from the head a length sufficient to provide leverage to rotate the locking bar when the head engages the bar bracket of the locking bar.

Other embodiments relate to methods of making a tool, comprising:
forming a head comprising a front face and a rear face that together define a top edge, the head further comprising two tabs extending from the top edge in substantially the same plane as the head, wherein the two tabs are spaced apart along the top edge a distance sufficient to accommodate a bar bracket of a locking bar on a shipping container door;
attaching a handle to the head distal from the top edge and the tabs;
causing the tabs to extend from the front face to form extensions, thereby making the tool.

While the disclosure provides certain specific embodiments, the invention is not limited to those embodiments. A person of ordinary skill will appreciate from the description herein that modifications can be made to the described embodiments and therefore that the specification is broader in scope than the described embodiments. All examples are therefore non-limiting.

### BRIEF DESCRIPTION OF THE DRAWINGS

FIG. 1 depicts, in a right-side perspective drawing, a tool 100 according to one embodiment of the invention.

FIG. 2 depicts the tool 100 in a front-side perspective drawing.

FIG. 3 depicts an embodiment of a tool in a top-down perspective drawing.

FIG. 4 depicts an embodiment of the head portion of a tool in an off-center perspective drawing.

FIG. 5 depicts another embodiment of the head portion of a tool.

FIGS. 6A and 6B depict an embodiment of a tool engaging the bar bracket of a locking bar on a shipping container door.

FIGS. 7, 8, and 9 depict a further embodiment of a tool having a door opening portion useful for opening a shipping container door. FIG. 7 depicts a partial right-side view;

FIG. 8 depicts a partial front-side view; and

FIG. 9 depicts a perspective view of a tool 700.

FIGS. 10, 11, and 12 depict a further embodiment of a tool having a winch turning portion useful for turning a winch to tighten a load-securing band or strap. FIG. 10 depicts a partial back-side view;

FIG. 11 depicts a partial left-side view; and

FIG. 12 depicts a perspective view of a tool 1000.

FIG. 13 depicts another embodiment of the head portion of a tool in an off-center perspective drawing.

FIGS. 14 and 15 depict a further embodiment of a tool having a bolt-turning feature at the distal end of handle 1460 of tool 1400. FIG. 14 depicts a partial front-side view; and

FIG. 15 depicts a partial right-side view.

FIGS. 16 and 17 depict an additional embodiment of a tool 1600 having a rod 1662 affixed to the distal end of handle 1660 and terminating in a pry bar 1662 with a nail puller 1675. FIG. 16 depicts a partial front-side view; and

FIG. 17 depicts a partial right-side view.

FIG. 18 depicts a further embodiment of the head portion 1810 of a tool 1800 in a partial off-center perspective view.

### DESCRIPTION OF EMBODIMENTS

As required, detailed embodiments of the present invention are disclosed herein; however, it is to be understood that the disclosed embodiments are merely exemplary of the invention that may be embodied in various forms. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that don't negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and/or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b, and c. Similarly, the phrase: “a method involving steps a, b, and c” means that the method includes at least steps a, b, and c.

A “shipping container” refers to any vessel employing locking bars and a door structure. Shipping containers include, for example, intermodal containers typically made of steel that are also known as ISO containers, truck transport containers such as those appearing on tractor trailers and on box trucks, containers useful in rail transport such as railway boxcars, and the like. “Closing a shipping container door,” as used herein, refers to, in some aspects, closing the door; while in other aspects, it refers to latching a locking handle to secure the door in a closed condition. Either closing or latching can be hampered by any number of reasons, including cargo movement, physical damage to the door, hinges, and/or locking bar mechanism due to collision or corrosion, and the like.

The head of the tool can be any suitable shape. In some cases, the head is substantially flat, while in other cases, it is curved. The top edge can have any suitable shape, such as square, curved, pointy, polygonal, and combinations thereof. The position and shape of the two extensions can meet any suitable configuration. The extensions, in some instances, are spaced apart along the top edge of the head a distance sufficient to accommodate a bar bracket of a locking bar on a shipping container door. The tool also contains a handle extending from the head a length sufficient to provide leverage to rotate the locking bar when the head engages the bar bracket of the locking bar. The handle can be any suitable shape. It can be substantially linear, or it can contain one or more bends, curves, even pivot points to allow the tool to reach different angles.

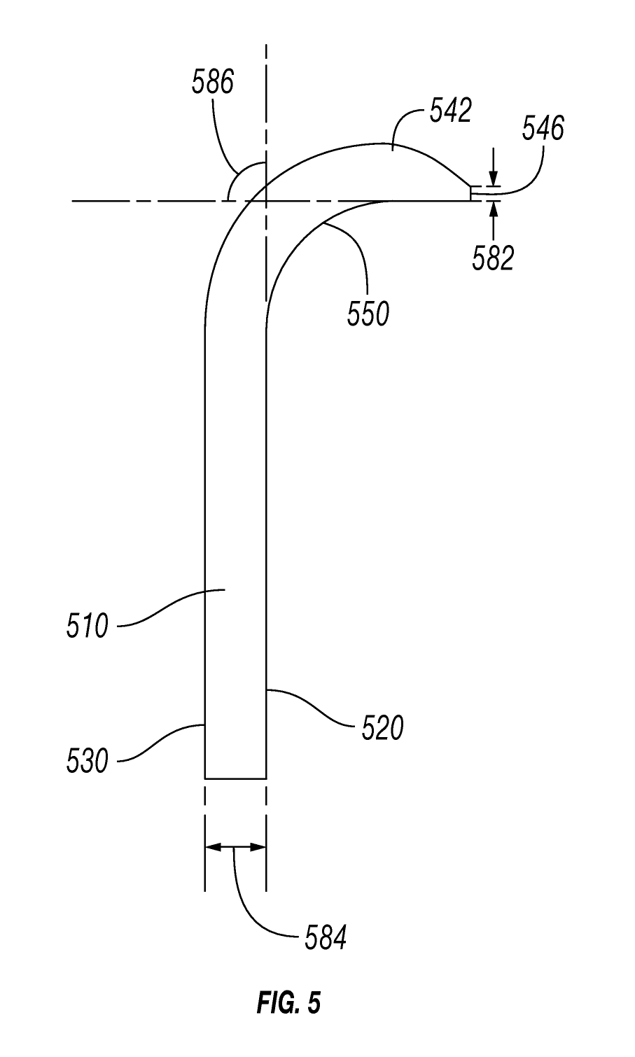

The extensions that engage the bar bracket of the locking bar can have any suitable shape. The extensions can be curvilinear, meaning having one or more curved portions and one or more linear portions. Or, the extensions can have multiple facets, with each facet at an angle from the previous facet to cause the extensions to hook around toward the front face of the head of the tool. In some instances, the two extensions define a curved arc between the front face and the ends of the extensions distal from the front face. In other instances, the curved arc is substantially circular for at least a portion of the arc. Further instances provide a tool, wherein the two extensions define an angle between the front face and the ends of the extensions distal from the front face. An example of this angle appears in FIG. 5. In that case, the two extensions define a curved arc proximal to the front face, and terminate in substantially linear ends distal from the front face.

The extensions terminate at their ends. Those ends can have any suitable shape. In some cases, the two extensions taper at their ends distal from the front face. Certain cases provide the two extensions each taper to a point or an edge. In further cases, the two extensions have ends distal from the front face that have a thickness at least half the thickness of the plate that makes up the head of the tool. In still further cases, the two extensions have ends distal from the front face that have a thickness at least three quarters the thickness of the head. Yet additional cases provide the two extensions having ends distal from the front face that have a thickness at least 90% of the thickness of the head.

The extensions can be spaced along the top edge a distance sufficient to accommodate a bar bracket of a locking bar. Certain instances provide the distance sufficient to accommodate a bar bracket is at least about 3.0 inches, at least about 3.25 inches, or at least about 3.5 inches.

The various parts of the tool can have any desired thickness or dimensions. Some embodiments provide the head having a thickness (in certain cases meaning the distance between the front face and the rear face) of at least about 0.25 inches, at least about 0.375 inches, or at least about 0.5 inches. In other embodiments, the two extensions extend at least about 1 inch from the front face, at least about 1.5 inches from the front face, or at least about 2 inches from the front face. Further embodiments provide that the length of the handle is sufficient to provide leverage to close the shipping container door. In additional embodiments, the length of the handle is at least about 1 foot, at least about 2 feet, or at least about 3 feet. The total length of the tool can be any suitable distance. In some cases, the total length of the tool is at least about two feet, or at least about three feet. In other cases, the total length of the tool is no more than about four feet.

Further embodiments provide a handle having any suitable additional features. In certain instances, the handle further comprises at least one hole distal from the head having a diameter sufficient to engage a twist lock handle of a shipping container coupler. In further instances, the diameter of at least one hole distal from the head is at least about 0.5 inches, at least about 0.875 inches, or at least about 1.0 inch. In additional instances, the hole is at least about 1.0 inch from the end of the handle distal from the head, or at least about 2.0 inches from the end of the handle distal from the head, measured from the nearest edge of the hole to the end of the handle distal from the head. Yet additional instances provide a hole in the handle at a position distal from the head, wherein the hole is no more than about 10 inches from the end of the handle distal from the head, measured from the nearest edge of the hole to the end of the handle distal from the head.

Broadly, the end of the handle distal from the head can comprise any suitable features. In one embodiment, the handle comprises a steel pipe, and a hole appears in the end of the handle distal from the head in one wall of the steel pipe. In another embodiment, two holes appears in the end of the handle distal from the head in two walls of the steel pipe, such as to accommodate a lever passing through both holes of the pipe. In a further embodiment, one or both holes are circular. In an additional embodiment, one or both holes are hexagonal or polygonal, such as to accommodate a nut or bolt. In yet a further embodiment, two holes appear, and one of the holes contains a small bar such that the bar fits into a groove on a bolt head in the manner of a flathead screwdriver, so the tool can manipulate the bolt. The small bar can be formed by any suitable means, such as by welding the small bar across the hole. In certain embodiments, the holes can be any suitable shape, such as circular, hexagonal, and/or polygonal, and the two holes can have the same or different shapes.

In a further embodiment, the end of the handle distal from the head can comprise a load winch turner. As shown in U.S. Pat. No. 4,045,002, which is incorporated herein by reference, a winch barrel can take up a band to secure a load on a truck bed. The winch barrel has a cap (item 9 in the '002 patent) extending outside the winch body and containing bore holes (item 4 in the '002 patent) into which a crank can be inserted. Certain embodiments of the present invention can include a metal pin extending from the handle distal from the head adapted to engage a bore hole in a winch barrel cap, so the tool can be used to turn the winch. The pin can be made in any suitable fashion. For example, two holes can be drilled in the handle, and the pin can be inserted in those holes so that a portion of the pin extends beyond the handle sufficiently to engage the bore hole. Or the pin can extend no farther than the surface of the handle. See FIG. 11. One of the two holes can match the diameter of the pin, and the second hole can be larger to accommodate the circumference of the cap. Optionally, the pin can be secured to the handle by welding. Still another embodiment provides the handle terminating in an edge, so that together with the handle, the tool can operate as a pry bar. Certain instances of that embodiment provide a shallow curve or bend in the handle a few inches from the edge to provide a fulcrum. Further instances provide a handle that is a steel pipe, into which is inserted a rod of steel that terminates in an edge, at the end of the pipe distal from the head of the tool. The rod optionally comprises a curve or bend suitable to act as a fulcrum. The rod is secured inside the handle, such as by welding, riveting, bolting, or a combination thereof.

In a further embodiment, the end of the handle distal from the head can include a feature suitable for opening a shipping container door. For example, the handle can be made of pipe steel that is wide enough to fit over and engage a locking handle on a shipping container door. In another example, the handle can be made of pipe steel that is flattened slightly to create an opening that is wide enough to fit over and engage a locking handle on a shipping container door. If the handle of the tool is flattened, the plane of the flat part of the handle can form any suitable angle with the head of the tool. In some cases, the plane of the flat part of the handle is parallel with the head of the tool. In other cases, the plane of the flat part of the handle is perpendicular to the head of the tool. In still other cases, the plane of the flat part of the handle forms any other angle, such as 45°, with the head of the tool. An elongate opening suitable for fitting over an engaging a locking handle on a shipping container door can be made by any suitable procedure. In one example, the handle comprises a metal pipe that can be heated to a temperature sufficient to soften the metal, whereupon a press or other force is used to flatten but not entirely close the end of the pipe distal from the head. In another example, a device comprising an elongate opening can be attached to the end of the handle by any suitable means, such as by welding, riveting, bolting, gluing, or a combination thereof.

The materials of the tool are not limited. The tool can comprise, for example, steel, tempered steel, wood, plastic, or a combination thereof. In certain embodiments, the head comprises steel having a thickness of about 0.375 inches. In further embodiments, the handle comprises pipe steel having a thickness of about 0.125 inches.

Certain embodiments of the present invention also relate to methods of making the tool. Tools according to the present invention can be made in any suitable manner. The various parts of the tool can be made in any suitable order. The tool can be made from a single piece of material, or from multiple pieces of alike or different material that are then joined together in any suitable manner. Welding, bolting, riveting, screwing, stapling, nailing, applying one or more adhesives, and the like can be used, alone or in combination, to join together one or more pieces of a tool. For example, in one embodiment, forming the head comprises cutting a steel plate in the shape of the head with the two tabs. In a further embodiment, attaching the handle comprises welding a steel pipe to the head. In an additional embodiment, causing the tabs to extend comprises heating the tabs to a temperature sufficient to bend the tabs to form extensions. Heating can be accomplished in any suitable manner, such as with an oven, a welding torch, an induction heater, or a combination thereof. Yet further embodiments allow for grinding the extensions to taper the two extensions at their ends distal from the front face.

Further embodiments of the present invention relate to methods for closing a shipping container door. In one such method, a tool such as one of those described herein is provided. An operator causes the two extensions to engage the bar bracket of a locking bar on the shipping container door. The operator uses the handle of the tool to press against the door to close the door, while pivoting the tool engaging the bar bracket so the locking handle of the locking bar secures the door in a closed condition.

Additional embodiments relate to using certain of the tools described herein to couple or uncouple a shipping container from another shipping container, a stationary mount, or a truck chassis. Those additional embodiments employ the hole or holes in the handles of the tools of the present disclosure to engage a handle of the twist lock mechanism coupling the shipping container, pivot the twist lock handle, and thereby couple or uncouple the twist lock. “Twist lock” refers to those shipping container coupling devices developed by Keith W. Tantlinger, including those reported in U.S. Pat. No. 3,027,025, which patent is incorporated herein by reference in its entirety. Such embodiments of the present invention allow a trucker, for example, to carry one fewer tool, as the tool contains implements for two separate tasks relating to a shipping container, namely, a door-closing implement and a coupling implement.

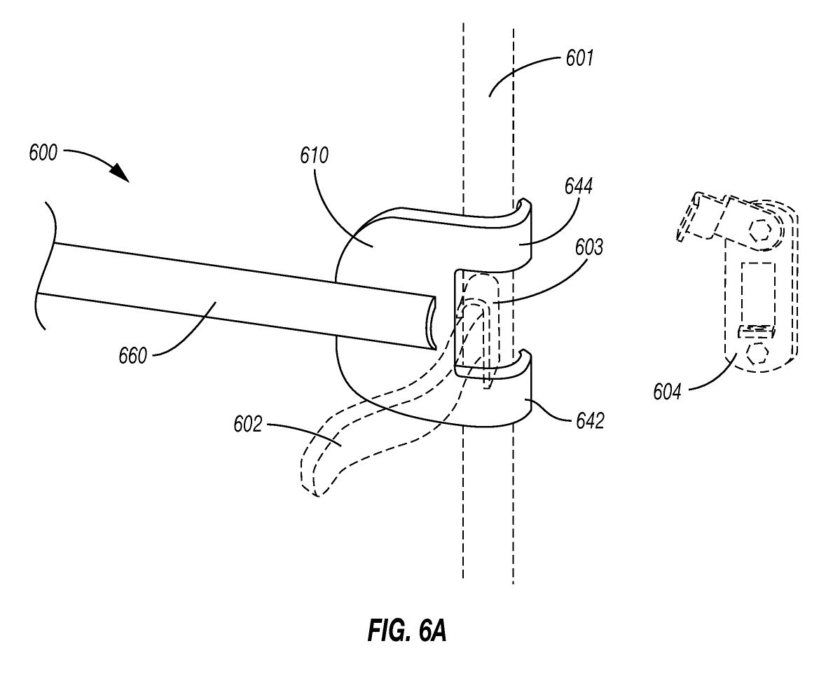

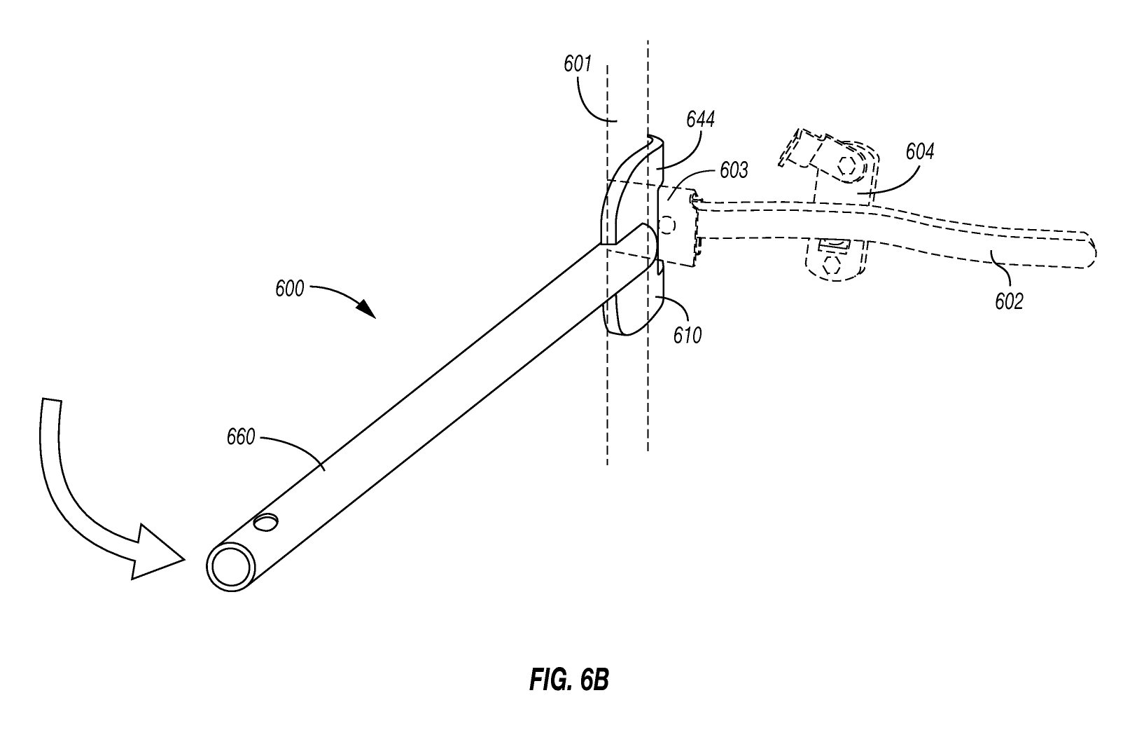

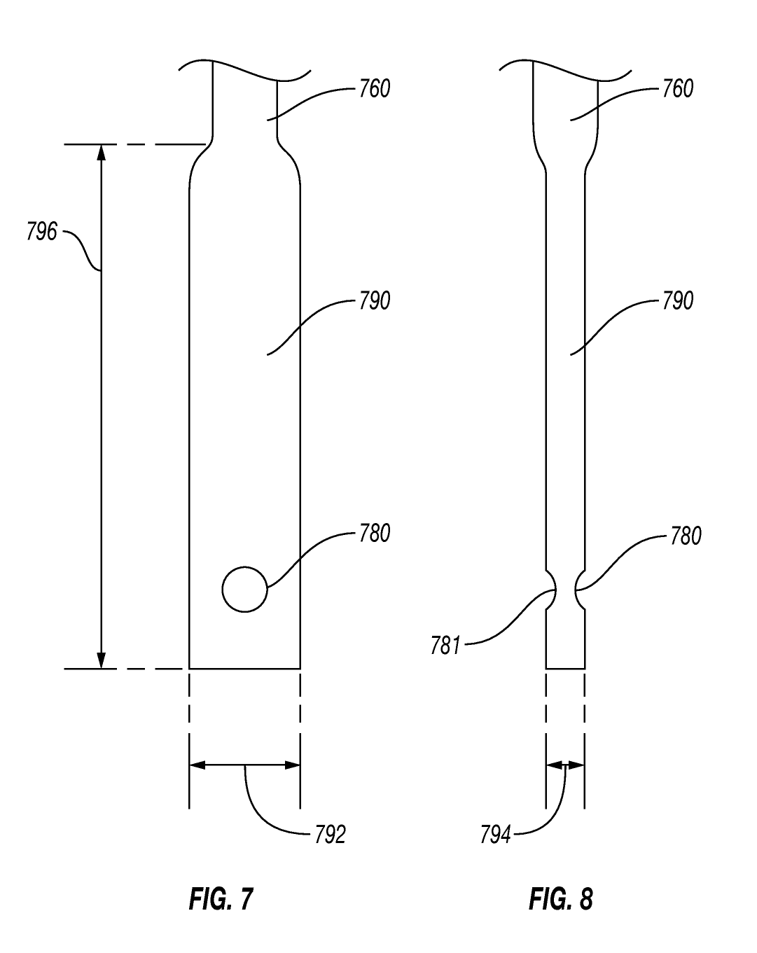

Still further embodiments of the present invention relate to methods for opening a shipping container door. In one such method, a tool such as the one shown in FIGS. 7, 8, and 9 is provided. An operator causes the door opening portion at the end of the handle distal from the head to engage the locking handle of a locking bar on the shipping container door. The operator uses the handle of the tool to leverage the locking handle to move away from the latch, causing the locking bar to disengage and open the door, while keeping clear of the tool and the locking handle in case pressure on the door or other force might cause the tool or the locking handle to move at a dangerous speed. In another method, a tool such as the embodiment shown in FIG. 6B is provided. The handle 660 is made of pipe steel having an internal diameter sufficient to fit over and engage a locking handle 602. In the manner described above, an operator uses the handle of the tool to leverage the locking handle to move away from the latch, causing the locking bar to disengage and open the door, while keeping clear of the tool and the locking handle in case pressure on the door or other force might cause the tool or the locking handle to move at a dangerous speed.

### INDUSTRIAL APPLICABILITY

Applicant has discovered a new and useful means for closing and securing the doors of intermodal shipping containers, the doors of tractor-trailers and box trucks, railway boxcars, and similar vessels for transporting cargo. Other industrially-useful applications appear mentioned throughout this application.

### DETAILED DESCRIPTION OF THE DRAWINGS

Further embodiments of the present invention can be described by reference to the accompanying drawings.

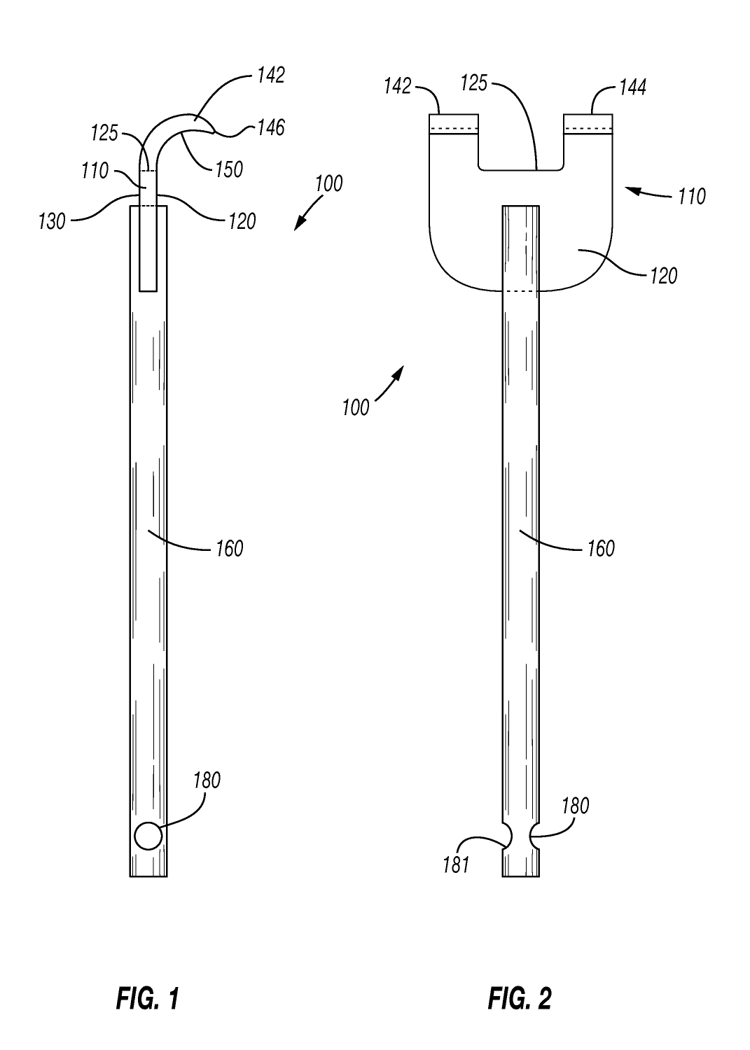

FIG. 1 depicts, in a right-side perspective drawing, a tool 100 according to one embodiment of the invention. The left-side perspective view is the mirror image of the right-side perspective view. The tool 100 has a head 110 comprising a front face 120 and a rear face 130 that together define a top edge 125, from which front face 120 two extensions (only one extension 142 is visible in FIG. 1) extend. The extension 142 defines a curved arc 150 between the front face 120 and the end 146 of the extension 142. The tool 100 also has a handle 160 extending from the head 110 a length sufficient to provide leverage to rotate a locking bar when the head 110 engages the bar bracket of the locking bar on a shipping container. The handle 160 also includes a pair of aligned holes 180, 181 having a diameter sufficient to engage a twist lock handle of a shipping container coupler.

FIG. 2 depicts the tool 100 in a front-side perspective drawing. The back-side perspective view is nearly identical to the front-side perspective view, except extensions 142, 144 would extend away from the viewer in the back-side perspective view. The head 110 has a front face 120 from which extend two extensions 142, 144. Those extensions 142, 144 are proximal to the top edge 125 of head 110, and are spaced apart along the top edge 125 a distance sufficient to accommodate a bar bracket of a locking bar on a shipping container door. A handle 160 is attached to and extends from the head 110. At the end of the handle 160 distal from the head 110, a pair of aligned holes 180, 181 appears. The holes 180, 181 have a diameter sufficient to engage a twist lock handle of a shipping container coupler.

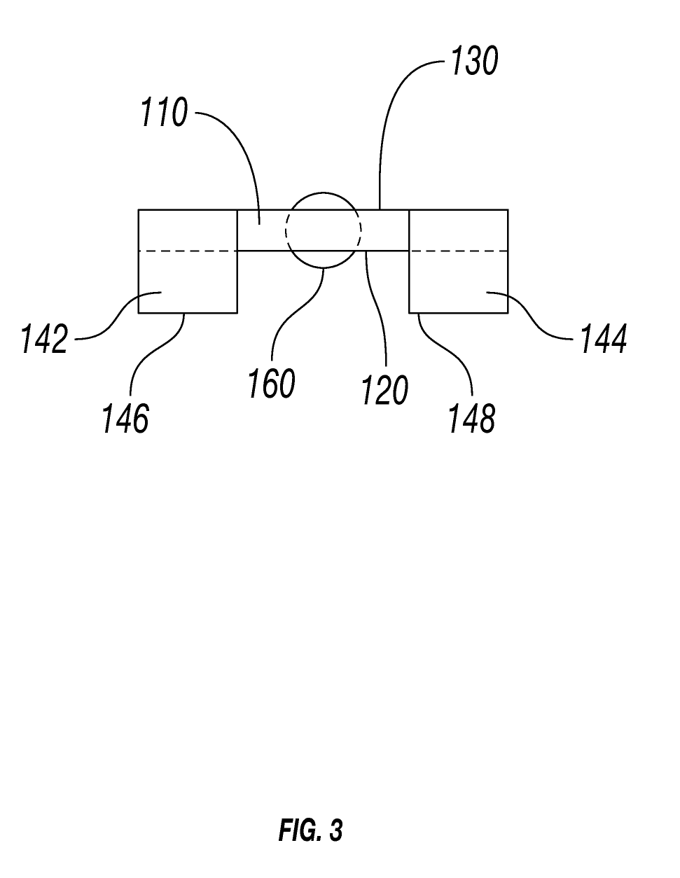

FIG. 3 depicts an embodiment of a tool according to the present invention in a top-down perspective drawing. Head 110 has a front face 120 and a rear face 130, and two extensions 142, 144 extending from the front face 120. Extension 142 terminates in an end 146, and extension 144 terminates in an end 148. Also visible is the handle 160 attached to head 110. The bottom-up perspective view is nearly identical to the top-down perspective, except for certain components showed in dotted lines.

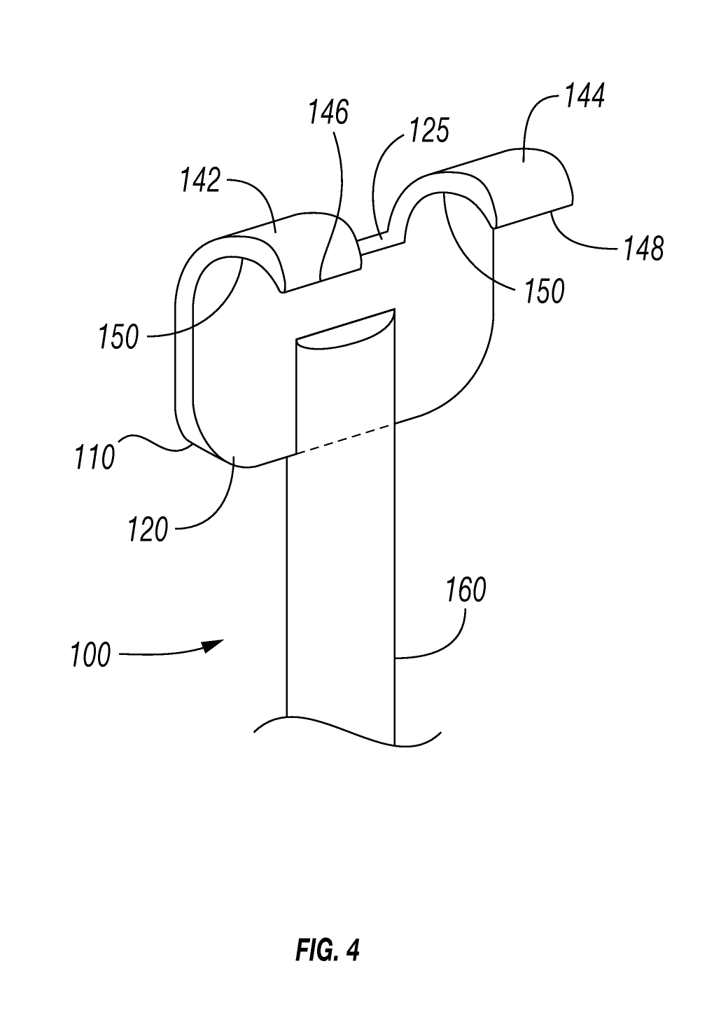

FIG. 4 depicts an embodiment of the head portion of a tool in an off-center perspective drawing. Tool 100 has a head 110, which has a front face 120. Extension 142 and extension 144, both proximal to the top edge 125, extend from the front face 120 and are spaced apart along the top edge 125 a distance sufficient to accommodate a bar bracket of a locking bar on a shipping container door. Extension 142 terminates in an end 146, and extension 144 terminates in an end 148. Both extensions 142, 144 define a curved arc 150 between the front face 120 and the ends 146, 148 of the extensions 142, 144. In some cases, the curved arc 150 is substantially circular for at least a portion of the curved arc 150. Handle 160 extends from head 110 for a length sufficient to provide leverage to rotate the locking bar when the head 110 engages the bar bracket of the locking bar.

FIG. 5 depicts another embodiment of the head portion of a tool. Viewed from the right side, head 510 has a front face 520 and a rear face 530. Extension 542 extends from the front face 520, and terminates in end 546. The extension 542 defines a curved arc 550 proximal to the front face 520 that terminates in a substantially linear end 546 distal from the front face 520. Extension 542 also tapers at its end 546 distal from the front face 520. End 546 has a thickness 582 that is less than the thickness 584 of the head 510. In some cases, the thickness 582 is at least half the thickness 584. Extension 542 defines an angle 586 between the front face 520 and the end 546 distal from the front face 520. Angle 586 can be any suitable angle. In some cases, angle 586 is at least about 30°, at least about 45°, at least about 60°, or at least about 90°. In other cases, angle 586 is no more than 170°, no more than 120°, or no more than about 90°.

FIGS. 6A and 6B depict an embodiment of a tool 600 engaging the bar bracket 603 for a locking bar 601 on a shipping container door, to close and latch the door safely and securely. Referring to FIG. 6A, tool 600 has a head 610 attached to a handle 660. Extensions 642 and 644 allow the tool 600 to accommodate a bar bracket 603 of a locking bar 601 on a shipping container door. Locking handle 602 extends from the bar bracket 603. FIG. 6A shows the locking bar in an “open” configuration, since the locking handle 602 is not secure in the latch 604. Referring to FIG. 6B, pivoting the tool 600 engaged with the bar bracket 603 rotates the locking bar 601, bringing the locking handle 602 into proximity to latch 604. Tool 600 has head 610 with extension 644 and handle 660 visible. Tool 600 allows the latching of the locking handle 602 in latch 604 in a manner much safer than applying the force of a forklift against bar bracket 603 and locking handle 602, and having an operator manually engage latch 604. As explained above, without tool 600, the forklift could slip, causing locking handle 602 to swing rapidly, endangering the operator.

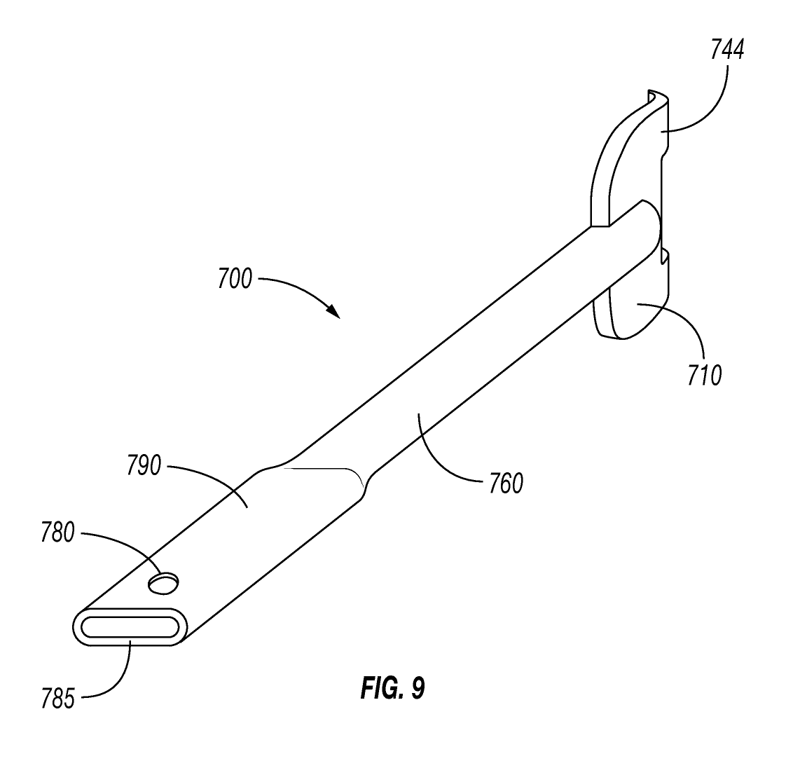

FIGS. 7, 8, and 9 show another embodiment of the tool 700 that has a door opening portion suitable for engaging a locking handle 602 as seen in FIG. 6B. FIG. 7 depicts a partial right-side view; FIG. 8 depicts a partial front-side view, and FIG. 9 depicts a perspective view of a tool 700. Handle 760 comprises pipe steel that has been heated and pressed to form a flat portion 790. Handle 760 has been welded to head 710 which comprises extension 744 for engaging the bar bracket 603 of a locking bar 601 on a shipping container door (see also FIG. 6B). The door opening portion comprises, in this embodiment, flat portion 790 and opening 785. Flat portion 790 has dimensions 792, 794, and 796 that are suitable to engage a locking handle 602 of a shipping container door. Accordingly, the tool 700 can fit over and engage a locking handle 602, and thereby provide leverage to an operator to open a stuck, damaged, corroded, or otherwise difficult locking bar 601. Those dimensions 792, 794, and 796 are not limited. In some cases, dimension 792 is at least 1.5 inches, at least 2 inches, at least 2.5 inches, at least 3 inches, or at least 4 inches. Dimension 794 can be, for example, at least a half-inch, at least 0.75 inches, at least 1 inch, at least 1.5 inches, at least 2 inches, or at least 2.5 inches. Dimension 796 can be, for example, at least 3 inches, at least 6 inches, at least 9 inches, at least one foot, or at least 1.5 feet. Dimension 796 need not accommodate the entire length of a locking handle 602. In some cases, the door opening portion fits over a locking handle 602 and slides all the way to a bar bracket 603. In other cases, the door opening portion fits over a locking handle 602 only a fraction of the distance from the tip of the locking handle 602 to the bar bracket 603. When selecting dimensions 792, 794, and 796, the skilled artisan may take into account the thickness of the material such as pipe steel being used to form the flat portion 790, so that the opening 785 and the flat portion 790 will fit over and engage a locking handle 602. Because many locking bars have different dimensions and designs, the dimensions 792, 794, and 796 can be selected so that there is engagement, but not necessarily a low-tolerance tight fit, between the flat portion 790 and locking handle 602, in certain embodiments. Tool 700 also has a hole 780 through both walls of the flat portion 790. Hole 780 can have any suitable dimension, such as a diameter sufficient to engage a twist lock handle of a shipping container coupler. The skilled artisan will appreciate the danger when using the tool 700 to open a damaged or stuck shipping container door. It is possible that locking handle 602 could spring open at great velocity once initial resistance has been overcome, endangering the person trying to open the shipping container door. If tool 700 is engaged with the locking handle 602 through the opening 785, the entire tool 700 also could swing with the locking handle 602 at great velocity, and potentially disengage from the locking bar and injure a person or damage property some distance from the shipping container door. Accordingly, the operator should employ a technique that removes people and property from the potential path of the locking handle 602 and the tool 700 when opening a shipping container door in that manner. The partial left-side view is identical to the partial right-side view seen in FIG. 7. The partial back-side view is identical to the partial front-side view seen in FIG. 8.

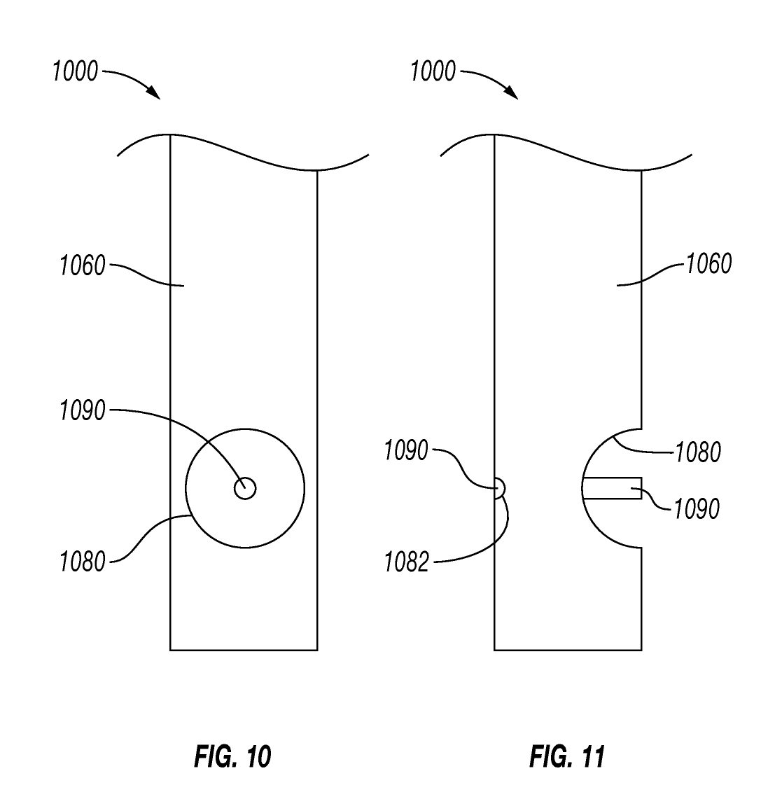

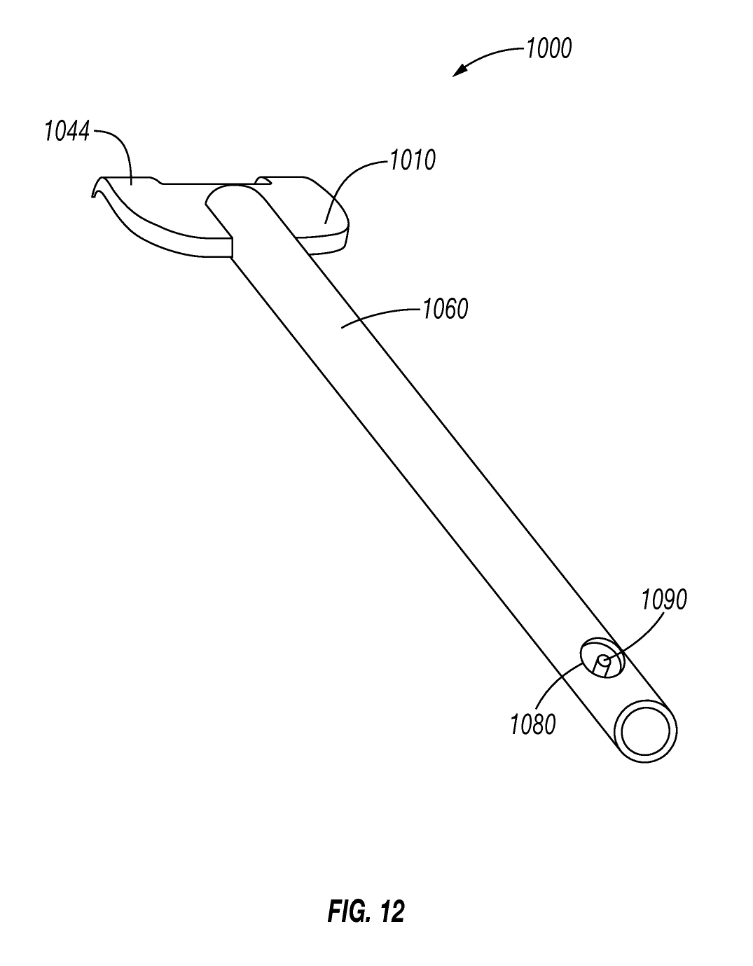

FIGS. 10, 11, and 12 depict a further embodiment of a tool having a winch-turning portion useful for turning in winch to tighten a load-securing band or strap. FIG. 10 depicts a partial back-side view; FIG. 11 depicts a partial left-side view; and FIG. 12 depicts a perspective view of a tool 1000. The winch-turning portion of tool 1000 comprises the distal portion of handle 1060 having hole 1080 exposing pin 1090. Hole 1080 and pin 1090 are sized and configured to engage a bore hole in a winch barrel cap, so the tool 1000 can be used to turn the winch. The winch-turning portion can be made in this instance by forming hole 1080 and hole 1082 in handle 1060, welding pin 1090 into hole 1082, and optionally grinding any portion of pin 1090 that extends beyond the handle 1060 through hole 1082. Holes 1080, 1082 together with pin 1090 can be oriented in any desired manner relative to head 1010 having among other features extension 1044. As shown in FIG. 12, pin 1090 emerges from the back side of handle 1060, if extension 1044 is considered to emerge from the front side of head 1010. The partial front-side view is identical to the partial back-side view shown in FIG. 10, except for the depiction of certain features in dotted lines. The partial right-side view is the mirror image of the partial left-side view shown in FIG. 11.

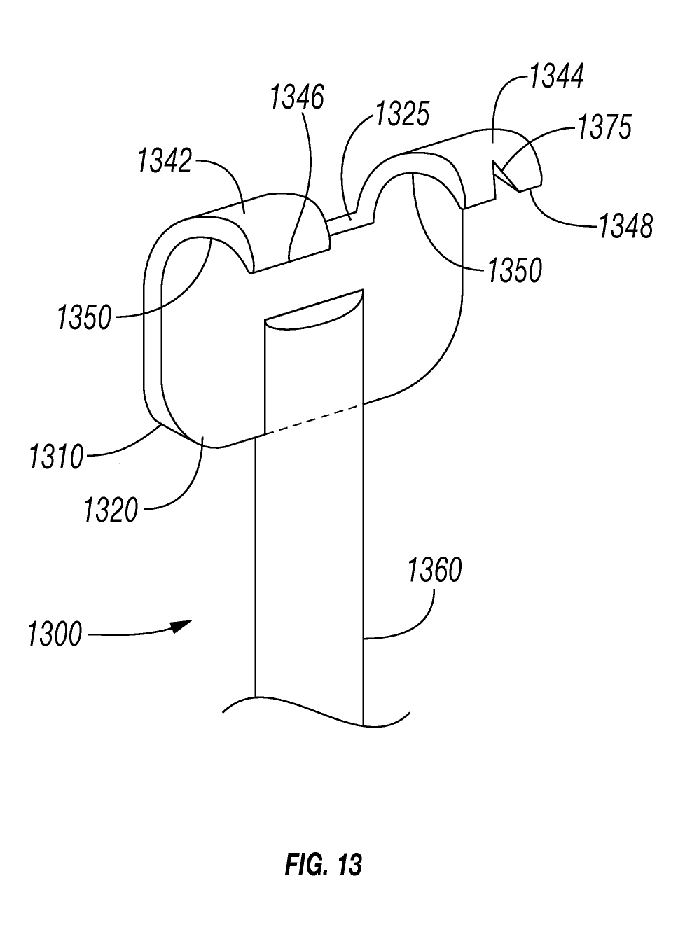

FIG. 13 depicts another embodiment of the head portion of a tool in an off-center perspective drawing. Tool 1300 has a head 1310, which has a front face 1320. Extension 1342 and extension 1344, both proximal to the top edge 1325, extend from the front face 1320 and are spaced apart along the top edge 1325 a distance sufficient to accommodate a bar bracket of a locking bar on a shipping container door. Extension 1342 terminates in an end 1346, and extension 1344 terminates in an end 1348. Extension 1344 further comprises a nail puller 1375 in end 1348. Both extensions 1342, 1344 define a curved arc 1350 between the front face 1320 and the ends 1346, 1348 of the extensions 1342, 1344. In some cases, the curved arc 1350 is substantially circular for at least a portion of the curved arc 1350. Handle 1360 extends from head 1310 for a length sufficient to provide leverage to rotate the locking bar when the head 1310 engages the bar bracket of the locking bar.

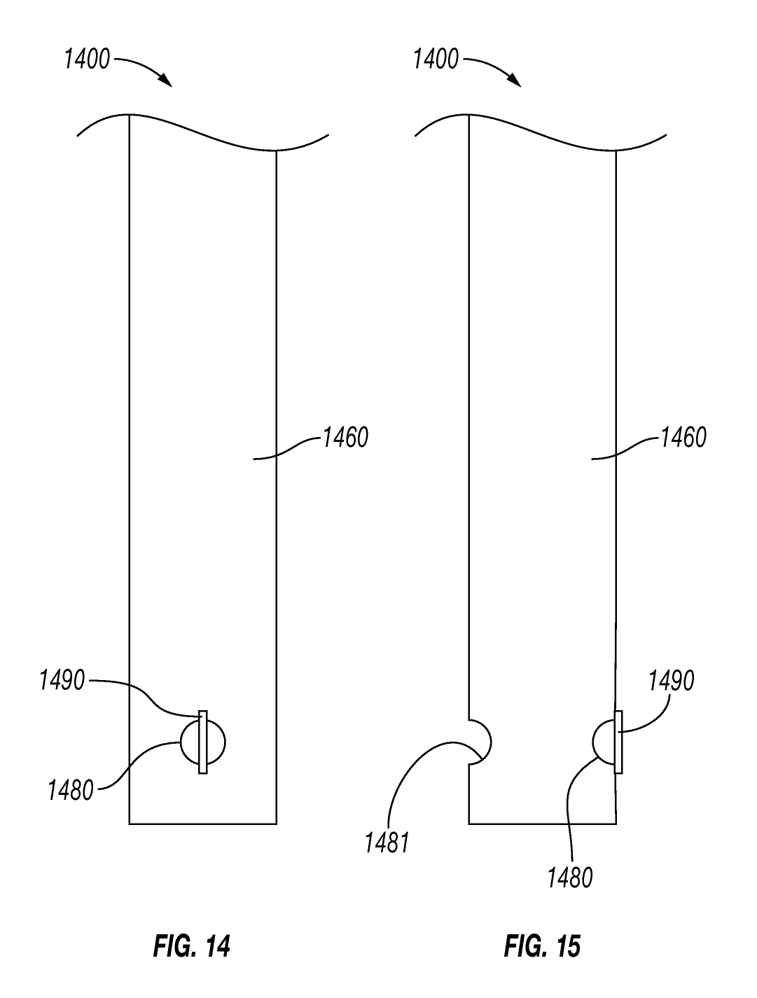

FIGS. 14 and 15 depict a further embodiment of a tool having a bolt-turning feature at the distal end of handle 1460 of tool 1400. FIG. 14 depicts a partial front-side view; and FIG. 15 depicts a partial right-side view. Small bar 1490 has been welded over circular holes 1480, 1481 in the distal end of handle 1460 of tool 1400, such that the small bar 1490 fits into a groove on a bolt head (not shown) in the manner of a flathead screwdriver, so the tool 1400 can manipulate the bolt. The bolt head would pass through hole 1481 and then hole 1480 to engage small bar 1490; or small bar 1490 could simply engage the groove on the bolt head without passing the bolt head through holes 1481, 1480. As can be appreciated, the bolt head could be associated with any desirable mechanism, such as a valve requiring significant leverage to open and close. In other embodiments, greater engagement can be obtained if one or both of holes 1480, 1481 are shaped to fit a specific bolt head, such as, for example, having a hexagonal shape. The partial back-side view is identical to the partial back-side view shown in FIG. 14, except for the depiction of certain features in dotted lines. The partial left-side view is the mirror image of the partial right-side view shown in FIG. 15.

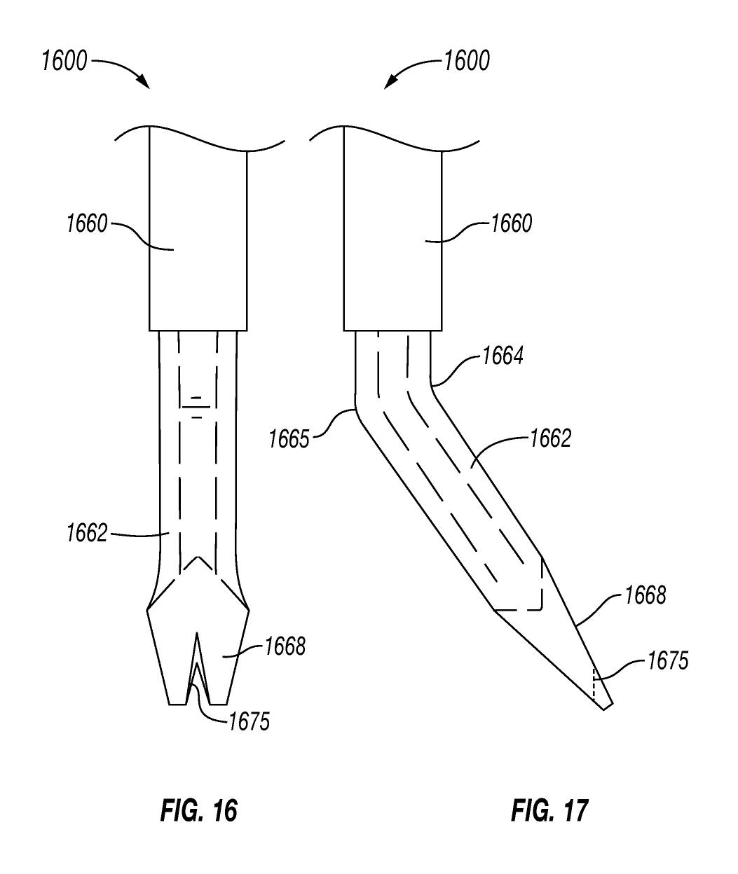

FIGS. 16 and 17 depict an additional embodiment of a tool 1600 having a rod 1662 affixed to the distal end of handle 1660 and terminating in a pry bar 1662 with a nail puller 1675. FIG. 16 depicts a partial front-side view; and FIG. 17 depicts a partial right-side view. Tool 1600 has a handle 1660 that is a steel pipe, into which has been inserted, and welded, a steel rod 1662, distal from the head (not shown) of tool 1600. Steel rod 1662 terminates in a prying feature 1668 which includes a nail puller 1675. Steel rod 1662 also has a bend 1664 that provides a fulcrum 1665 to aid the operation of prying feature 1668 and nail puller 1675. The partial back-side view is identical to the partial back-side view shown in FIG. 16, except for the depiction of certain features in dotted lines. The partial left-side view is the mirror image of the partial right-side view shown in FIG. 17.

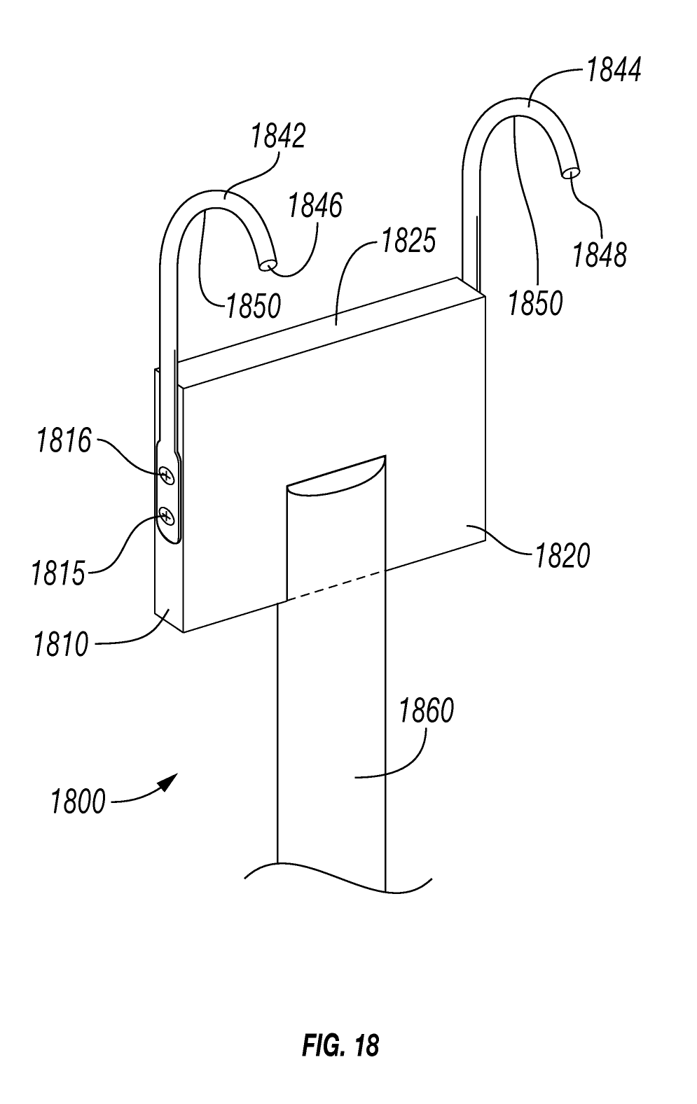

FIG. 18 depicts a further embodiment of the head portion 1810 of a tool 1800 in partial off-center perspective view. Tool 1800 has a head 1810, which has a front face 1820 and top edge 1825. Extension 1842 and extension 1844, both proximal to the top edge 1825, extend from the front face 1820 and are spaced apart along the top edge 1825 a distance sufficient to accommodate a bar bracket of a locking bar on a shipping container door. Extension 1842 terminates in an end 1846, and extension 1844 terminates in an end 1848. Both extensions 1842, 1844 define a curved arc 1850 between the front face 1820 and the ends 1846, 1848 of the extensions 1842, 1844. In some cases, the curved arc 1850 is substantially circular for at least a portion of the curved arc 1850. Extensions 1842, 1844 in this embodiment comprise ¼-inch steel wire that has been pre-formed into the desired shape shown here before attaching to head 1810. Extensions 1842, 1844 are attached to head 1810 by screws such as screws 1815, 1816 that attach extension 1842. Handle 1860 extends from head 1810 for a length sufficient to provide leverage to rotate the locking bar when the head 1810 engages the bar bracket of the locking bar.

### EMBODIMENTS

### Embodiment 1

A tool for closing a shipping container door, comprising:

a head that comprises
a front face and a rear face that together define a top edge;
two extensions proximal to the top edge extending from the front face, and
spaced apart along the top edge a distance sufficient to accommodate a bar bracket of a locking bar on the shipping container door;
   a handle extending from the head a length sufficient to provide leverage to rotate the locking bar when the head engages the bar bracket of the locking bar.

### Embodiment 2

The tool of embodiment 1, wherein the two extensions define a curved arc between the front face and the ends of the extensions distal from the front face.

### Embodiment 3

The tool of embodiment 2, wherein the curved arc is substantially circular for at least a portion of the arc.

### Embodiment 4

The tool of any one of embodiments 1 to 3, wherein the two extensions define an angle between the front face and the ends of the extensions distal from the front face.

### Embodiment 5

The tool of any one of embodiments 1 to 4, wherein the two extensions define a curved arc proximal to the front face, and terminate in substantially linear ends distal from the front face.

### Embodiment 6

The tool of embodiment 5, wherein the curved arc is substantially circular for at least a portion of the arc.

### Embodiment 7

The tool of any one of embodiments 1 to 6, wherein the two extensions taper at their ends distal from the front face.

### Embodiment 8

The tool of any one of embodiments 1 to 7, wherein the two extensions have ends distal from the front face that have a thickness at least half the thickness of the head.

### Embodiment 9

The tool of any one of embodiments 1 to 8, wherein the two extensions have ends distal from the front face that have a thickness at least three quarters the thickness of the head.

### Embodiment 10

The tool of any one of embodiments 1 to 9, wherein the two extensions have ends distal from the front face that have a thickness at least 90% of the thickness of the head.

### Embodiment 11

The tool of any one of embodiments 1 to 10, wherein the distance sufficient to accommodate a bar bracket is at least 3.0 inches.

### Embodiment 12

The tool of any one of embodiments 1 to 11, wherein the distance sufficient to accommodate a bar bracket is at least 3.25 inches.

### Embodiment 13

The tool of any one of embodiments 1 to 12, wherein the distance sufficient to accommodate a bar bracket is at least 3.5 inches.

### Embodiment 14

The tool of any one of embodiments 1 to 13, wherein the head has a thickness of at least 0.25 inches.

### Embodiment 15

The tool of any one of embodiments 1 to 14, wherein the head has a thickness of at least 0.375 inches.

### Embodiment 16

The tool of any one of embodiments 1 to 15, wherein the head has a thickness of at least 0.5 inches.

### Embodiment 17

The tool of any one of embodiments 1 to 16, wherein the two extensions extend at least 1 inch from the front face.

### Embodiment 18

The tool of any one of embodiments 1 to 17, wherein the two extensions extend at least 1.5 inches from the front face.

### Embodiment 19

The tool of any one of embodiments 1 to 18, wherein the two extensions extend at least 2 inches from the front face.

### Embodiment 20

The tool of any one of embodiments 1 to 19, wherein the length of the handle is sufficient to provide leverage to close the shipping container door.

### Embodiment 21

The tool of any one of embodiments 1 to 20, wherein the length of the handle is at least 1 foot.

### Embodiment 22

The tool of any one of embodiments 1 to 21, wherein the length of the handle is at least 2 feet.

### Embodiment 23

The tool of any one of embodiments 1 to 22, wherein the length of the handle is at least 3 feet.

### Embodiment 24

The tool of any one of embodiments 1 to 23, wherein the total length of the tool is at least two feet.

### Embodiment 25

The tool of any one of embodiments 1 to 24, wherein the total length of the tool is at least three feet.

### Embodiment 26

The tool of any one of embodiments 1 to 25, wherein the total length of the tool is no more than four feet.

### Embodiment 27

The tool of any one of embodiments 1 to 26, wherein the handle further comprises at least one hole distal from the head having a diameter sufficient to engage a twist lock handle of a shipping container coupler.

### Embodiment 28

The tool of embodiment 27, wherein the diameter is at least about 0.5 inches.

### Embodiment 29

The tool of any one of embodiments 27 to 28, wherein the diameter is at least about 0.875 inches.

### Embodiment 30

The tool of any one of embodiments 27 to 29, wherein the diameter is at least about 1.0 inch.

### Embodiment 31

The tool of any one of embodiments 27 to 30, wherein the hole is at least about 1.0 inch from the end of the handle distal from the head.

### Embodiment 32

The tool of any one of embodiments 27 to 31, wherein the hole is at least about 2.0 inches from the end of the handle distal from the head.

### Embodiment 33

The tool of any one of embodiments 27 to 32, wherein the hole is no more than about 10 inches from the end of the handle distal from the head.

### Embodiment 34

The tool of any one of embodiments 1 to 33, wherein the handle further comprises a load wench turner distal to the head.

### Embodiment 35

The tool of any one of embodiments 1 to 34, wherein the tool comprises steel.

### Embodiment 36

The tool of any one of embodiments 1 to 35, wherein the tool comprises tempered steel.

### Embodiment 37

The tool of any one of embodiments 1 to 36, wherein the head comprises steel having a thickness of about 0.375 inches.

### Embodiment 38

The tool of any one of embodiments 1 to 37, wherein the handle comprises pipe steel having a thickness of about 0.125 inches.

### Embodiment 39

The tool any one of embodiments 1 to 38, wherein the handle distal from the head comprises a door opening portion having dimensions suitable to fit over and engage a locking handle of a shipping container door.

### Embodiment 40

The tool of any one of embodiments 1 to 39, wherein the door opening portion further comprises at least one hole having a diameter sufficient to engage a twist lock handle of a shipping container coupler.

### Embodiment 41

The tool of any one of embodiments 1 to 40, further comprising a nail puller.

### Embodiment 42

The tool of embodiment 41, wherein the nail puller is present in one of the two extensions.

### Embodiment 43

A method of making a tool of any one of embodiments 1 to 42, comprising:
forming a head comprising a front face and a rear face that together define a top edge, the head further comprising two tabs extending from the top edge in substantially the same plane as the head, wherein the two tabs are spaced apart along the top edge a distance sufficient to accommodate a bar bracket of a locking bar on a shipping container door;
attaching a handle to the head distal from the top edge and the tabs;
causing the tabs to extend from the front face to form extensions,
thereby making the tool.

### Embodiment 44

The method of embodiment 43, wherein forming the head comprises cutting a steel plate in the shape of the head with the two tabs.

### Embodiment 45

The method of any one of embodiments 43 to 44, wherein attaching the handle comprises welding a steel pipe to the head.

### Embodiment 46

The method of any one of embodiments 43 to 45, wherein causing the tabs to extend comprises heating the tabs to a temperature sufficient to bend the tabs to form extensions.

### Embodiment 47

The method of any one of embodiments 43 to 46, further comprising grinding the extensions to taper the two extensions at their ends distal from the front face.

As previously stated, detailed embodiments of the present invention are disclosed herein; however, it is to be understood that the disclosed embodiments are merely exemplary of the invention that may be embodied in various forms. It will be appreciated that many modifications and other variations stand within the intended scope of this invention as claimed below. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

1. A tool for closing a shipping container door, comprising:
a head that comprises
a front face and a rear face that together define a top edge;
two extensions proximal to the top edge extending from the front face, and spaced apart along the top edge a distance sufficient to accommodate a bar bracket of a locking bar on the shipping container door;
a handle extending from the head a length sufficient to provide leverage to rotate the locking bar when the head engages the bar bracket of the locking bar.

2. The tool of claim 1, wherein the two extensions define a curved arc between the front face and the ends of the extensions distal from the front face.

3. The tool of claim 2, wherein the curved arc is substantially circular for at least a portion of the arc.

4. The tool of claim 1, wherein the two extensions define an angle between the front face and the ends of the extensions distal from the front face.

5. The tool of claim 1, wherein the two extensions define a curved arc proximal to the front face, and terminate in substantially linear ends distal from the front face.

6. The tool of claim 5, wherein the curved arc is substantially circular for at least a portion of the arc.

7. The tool of claim 1, wherein the two extensions taper at their ends distal from the front face.

8. The tool of claim 1, wherein the two extensions have ends distal from the front face that have a thickness at least half the thickness of the head.

9. The tool of claim 1, wherein the two extensions have ends distal from the front face that have a thickness at least three quarters the thickness of the head.

10. The tool of claim 1, wherein the two extensions have ends distal from the front face that have a thickness at least 90% of the thickness of the head.

11. The tool of claim 1, wherein the distance sufficient to accommodate a bar bracket is at least 3.0 inches.

12. The tool of claim 1, wherein the distance sufficient to accommodate a bar bracket is at least 3.25 inches.

13. The tool of claim 1, wherein the distance sufficient to accommodate a bar bracket is at least 3.5 inches.

14. The tool of claim 1, wherein the head has a thickness of at least 0.25 inches.

15. The tool of claim 1, wherein the head has a thickness of at least 0.375 inches.

16. The tool of claim 1, wherein the head has a thickness of at least 0.5 inches.

17. The tool of claim 1, wherein the two extensions extend at least 1 inch from the front face.

18. The tool of claim 1, wherein the two extensions extend at least 1.5 inches from the front face.

19. The tool of claim 1, wherein the two extensions extend at least 2 inches from the front face.

20. The tool of claim 1, wherein the length of the handle is sufficient to provide leverage to close the shipping container door.

21.-45. (canceled)
